(19) United States
(12) Patent Application Publication
(10) Pub. No.: US 2019/0378424 A1
(43) Pub. Date: Dec. 12, 2019

(54) BLOCK-BASED PLAYER CONSTRUCT IDENTIFICATION

(71) Applicant: FUJITSU LIMITED, Kawasaki-shi (JP)

(72) Inventors: Cong CHEN, Cupertino, CA (US); Ajay CHANDER, San Fransisco, CA (US); Kanji UCHINO, Santa Clara, CA (US)

(73) Assignee: FUJITSU LIMITED, Kawasaki-shi (JP)

(21) Appl. No.: 16/006,687

(22) Filed: Jun. 12, 2018

(51) Int. Cl. G09B 1/32; A63H 33/04; A63F 13/80

(52) U.S. Cl. CPC G09B 1/325; A63H 33/06; A63F 13/80; A63H 33/042

(57) ABSTRACT

A method may include obtaining a multiple known objects and a player construct, comparing the player construct to the known objects, and determining whether the comparison exceeds a matching threshold. If a comparison exceeds the matching threshold, the player construct is assigned to a class associated with one of the known objects, and a meaningfulness measurement can be determined. The meaningfulness measurement may be based on a quantity of player constructs, including the first player construct, a similarity between elements in the class, and a similarity between the class and one or more other classes. The player construct may be created using physical blocks embedded with sensors or electronic blocks.

### FIELD

The embodiments discussed in the present disclosure are related to identification of block-based player constructs.

### BACKGROUND

Guided play provides a way to understand how children think and learn. Block play in particular gives children a rich environment to build their language and spatial skills. There are many benefits that come with block play, such as reading, language, social skills, math, geometry, etc. However, children with developmental delays may encounter difficulties with block play.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One or more embodiments of the present disclosure may include a method. The method may include obtaining multiple known objects, and receiving a player construct. The method may also include comparing the player construct to the known objects to determine whether a comparison of the player construct and one of the known objects exceeds a matching threshold. The method may also include, based on the comparison exceeding the matching threshold, assigning the player construct to a class associated with the known object that exceeded the matching threshold. The method may additionally include determining a meaningfulness measurement based on a quantity of player constructs, including the player construct, that exceed the matching threshold with any of the known objects, a similarity between elements in the class, and a similarity between the class and one or more other classes.

The object and advantages of the embodiments will be realized and achieved at least by the elements, features, and combinations particularly pointed out in the claims.

It is to be understood that both the foregoing general description and the following detailed description are merely examples and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a system related to a block-based player construct;

FIGS. 2A and 2B illustrate a flowchart of an example method of determining a meaningfulness measurement based on a player construct;

FIGS. 3A and 3B illustrate a flowchart of an example method of classifying a player construct based on overlap with a known object;

FIG. 4A illustrates a flowchart of an example method of determining similarity between elements within a class;

FIG. 4B illustrates a flowchart of an example method of determining similarity between classes;

FIG. 5 illustrates a flowchart of another example method of determining a meaningfulness measurement;

FIG. 6 illustrates a flowchart of another example method of evaluating a player construct based on received language from a player that generated the player construct;

FIG. 7 illustrates a visual depiction of an example process by which a player construct may be converted from blocks to a set of edges and nodes;

FIG. 8 illustrates a visual depiction of an example process by which a comparison between player constructs or between a player construct and a known object may occur; and

FIG. 9 illustrates an example of a system including a computing device.

### DESCRIPTION OF EMBODIMENTS

The present disclosure relates to, inter alia, the identification of block-based player constructs. As used herein, a player construct includes a shape, figure, or other collection of individual blocks a player has generated using physical blocks and/or electronic blocks. For example, a child playing with blocks may build the blocks in the shape of a car, and the collection of blocks used to build the car may be referred to as a player construct of the child. Identification of such block-based player constructs may be used in developing meaningfulness measurements that may be insightful into the social, physical, or psychological development of the player generating the player constructs. For example, a child may generate various player constructs during block play. Embodiment of the present disclosure may attempt to classify or otherwise identify the player constructs based on their similarity with known objects. Using the player constructs that are classified, the present disclosure may determine a meaningfulness measurement. In some embodiments, the meaningfulness measurement may be based on how many player constructs were classifiable, the similarity between elements (e.g., identified player constructs) within a given class, and the similarity between the classes in which the player constructs were classified. Additionally, in some embodiments, the meaningfulness measurement may be used to provide a diagnosis of one or more developmental disorders that may be affecting the player.

Embodiments of the present disclosure are explained with reference to the accompanying drawings.

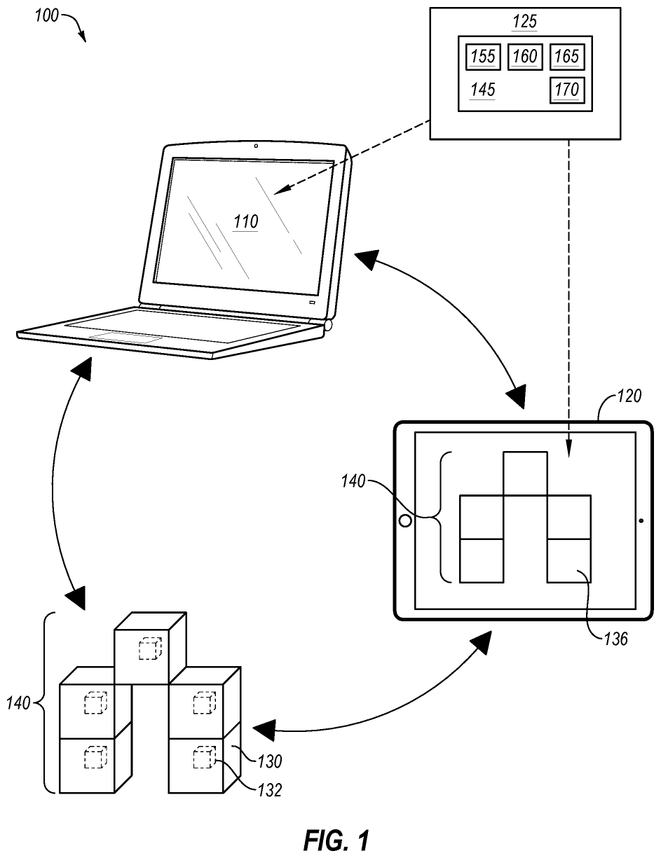

FIG. 1 illustrates an example of a system 100 related to a block-based player construct 140, in accordance with one or more embodiments of the present disclosure. The system 100 may include player constructs 140 generated via a computing device 110, a user device 120, electronic blocks 136, and/or physical blocks 130. The player constructs 140 may be identified and/or classified by the computing device 110 based on one or more known objects.

In some embodiments, a player, such as a child or other individual for which developmental questions may be important, may generate the player construct 140. For example, the player may be instructed to build a certain object with the physical blocks 130 and/or the electronic blocks 136. The player construct 140 generated by the player may be analyzed to determine whether the player construct 140 belongs to a class of known objects 110. A number of player constructs 140 may be generated by the player. The computing device 110 may attempt to classify each generated player construct. Based on the classifiable player constructs 140, the computing device 110 may determine a meaningfulness measurement for the player based on a variety of factors, such as the number of player constructs that are classifiable, the similarity between elements in a class, and the similarity between different classes.

In some embodiments, the player construct 140 includes the shape or figure or construction that the player has created with a block-based toy, including the physical blocks 130 and/or the electronic blocks 136. The player construct 140 may include a representation of the physical layout or shape of the blocks 130. The physical blocks 130 may include one or more construction toys such as building blocks or some other physical objects embedded with sensors 132, communication components for conveying data from the sensors, and/or processing components.

The player construct 140 may include a shape created from the physical blocks 130 or a shape generated using the electronic blocks 136. The shape may be an original shape generated by the player or it may be a shape that is guided and helped via instructions from user device 120 and/or the computing device 110. For example, the user device 120 and/or the computing device 110 may provide feedback based on where a given physical block 130 is located based on the sensor 132 such that the player may adjust the location of the given physical block 130 in generating the player construct 140. In these and other embodiments, the player construct 140 may be generated by the player without any help or guidance from an electronic device or another player. Additionally or alternatively, the player may begin generating a player construct by receiving help from the user device 120 or another player as a practice round. Then, the player may later move on to block building with no help, so that a stronger, more accurate meaningful measurement may be provided. When the player has completed his or her player construct 140, the player construct 140 may be received by the system 100, for example, at the computing device 110 and/or the user device 120. The computing device 110 and/or the user device 120 may receive information from the physical blocks 130 embedded with the sensors 132, from the electronic blocks 136, and/or from any other toy made of component parts that may be combined into a larger shape (e.g., into the player construct 140).

In these and other embodiments, the physical blocks 130 may include any number of physical blocks 130, and multiple, or even each of the physical blocks 130 may contain one or more sensors 132. The sensors 132 may indicate a block's location in relation to other blocks and/or to the block itself (for example, if the block is positioned tilted on its side versus in a normal vertical orientation). The physical blocks 130 may be used by a player to generate the player construct 140 using a physical modality rather than electronic modality. In some embodiments, the physical blocks 130 may be in communication with the computing device 110 and/or the user device 120. For example, the computing device 110 and/or the user device 120 may obtain data from the sensors 132 to determine the spatial relationship between the various physical blocks 130 to determine the overall shape of the player construct 140. Such communication may be over any modality, such as a Bluetooth® connection, a WiFi connection, a Near Field Communication (NFC), or any other communication modality.

The physical blocks 130 may include any type of object or component that may be combined with others to form a shape or object. For example, the physical blocks 130 may include wooden blocks, cloth blocks, unit blocks, foam blocks, large hollow blocks, LEGOS®, MAGFORMERS®, other magnetic blocks, other connecting blocks, tabletop blocks, homemade blocks, milk carton blocks, paper bag blocks, interlocking blocks, tree blocks, translucent color blocks, mirror blocks, colored window blocks, small unit blocks, large unit blocks, JENGA® blocks, alphabet blocks, wooden building planks, ROLKA® blocks, TENTE® blocks, RASTI® blocks, Lincoln Logs®, KEVA® planks, Zometools®, shape stackers, squeezable blocks, and/or other blocks. In some embodiments, the physical blocks 130 may or may not interlock or otherwise couple with each other in generating the player construct 140. The physical blocks 130 may take on any variety of geometric shapes and colors.

In some embodiments, the sensors 132 may be configured to identify a spatial location of a given block associated with a given sensor. The data from the embedded sensors 132 may be data representative of location data. For example, the sensors 132 may include an accelerometer, a gyroscope, etc. and may include multiple distinct sensors to facilitate determination of the spatial location of the given block.

In some embodiments, the physical blocks 130 may include a speaker or other component to generate audio to the player. For example, if the physical blocks 130 are not able to be connected, the speaker may inform the player to turn or rotate the block left or right or upside down. In these and other embodiments, the sensors 132 may include a device that detects a change in an electrical, physical, or other quantity and produces an output as indicative of that change. The output may be in the form of an electrical, optical, or other signal. Additionally or alternatively, the sensors 132 may be configured to measure position, temperature, magnetic state, electric current, rotation, etc. The sensor 132 may be configured as an absolute position sensor, a relative position sensor such as a displacement sensor, or any other type of sensor. In these and other embodiments, the sensor 132 may include a linear, angular, or a multi-axis sensor.

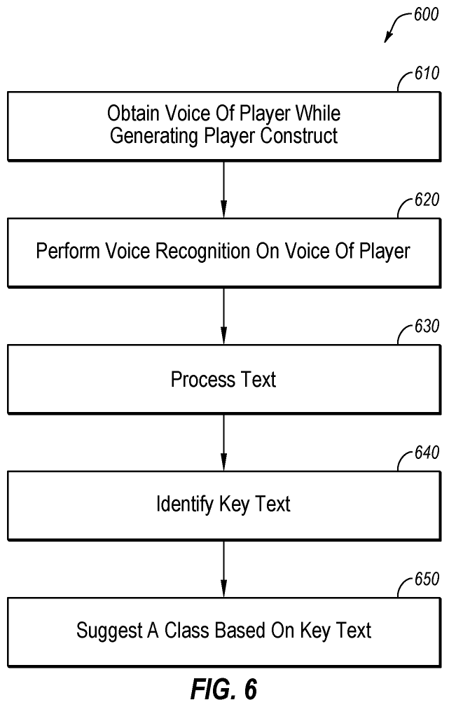

In some embodiments, the sensors 132 may include a microphone to capture audio while the player is using the physical blocks 130. For example, such a microphone may capture words spoken by the player while generating the player construct 140 and/or playing with the player construct 140. In these and other embodiments, such captured audio may facilitate determination of an appropriate class for the player construct 140. For example, if the player vocally describes the “horse” she is building, the computing device 110 may be more likely to classify the player construct 140 in a class associated with horses. An example of utilizing such words spoken by the player may be described in greater detail with respect to FIG. 6.

In some embodiments, a player may use an electronic modality rather than a physical modality to generate the player construct 140. For example, as illustrated in FIG. 1, in addition to or alternative to using physical blocks 130, a player may use the electronic blocks 136 to generate the player construct 140. For example, the player may use the user device 120, such as an electronic smart device including but not limited to an electronic tablet or a smart phone, to interact with one or more of the electronic blocks 136 to generate the player construct 140. In these and other embodiments, the electronic blocks 136 may be organized into a shape in a similar or comparable manner to the organization of the physical blocks 130 into a shape. Rather than using the sensors 132 to determine the physical location of the physical blocks 130, the user device 120 may determine a shape of the player construct 140 based on the location of the electronic blocks 140 relative to each other on a display area of the user device 120. A given electronic block 136 may be formed in any of a variety of geometric shapes. In these and other embodiments, the electronic blocks 136 may be moved around, rotated, etc. or otherwise interacted with by the player via the user device 120. For example, the player may generate a player construct 140 with the electronic blocks 136 using a touch screen, a computer mouse, a computer or tablet tracking pad, an earpiece, a stylus, a voice sensor, etc. Additionally or alternatively, the player may generate a player construct 140 using his or her own voice command, for example, “move the block up or to the left.” The player may use his or her finger or a stylus to move the digital blocks to different locations on the display of the user device 120.

In some embodiments, the player may generate the player construct 140 using the physical blocks 130, and have the shape of those blocks received in a digital image by the user device 120 via information obtained from the sensors 132 in the physical blocks 130. The player may be able to further manipulate or change this digital image by interacting with the digital image via the user device 120, and/or the physical blocks 130 themselves.

In some embodiments, a template may be obtained by the computing device 110 and/or the user device 120. The template may include one or more classes of known objects. In some embodiments, the template may include a variety of known objects of different classes, such as animals, nature attractions, physical structures, household objects, foods, methods of transportation, etc. Within these classes, the known objects may include one or more examples of elements found within that class, for example, bicycles, motorcycles, airplanes, trains, trucks, and cars may be found within the class of methods of transportation. In some embodiments, sub-classes may be contained within larger classes. For example, in a class of animals, sub-classes such as cats, dogs, tigers, giraffes, zebras, elephants, etc. may be included in the larger class of animals. In each of the sub-classes, there may be elements of known objects. For example, the sub-class of cats may include two or more images or constructs of known objects that are cats.

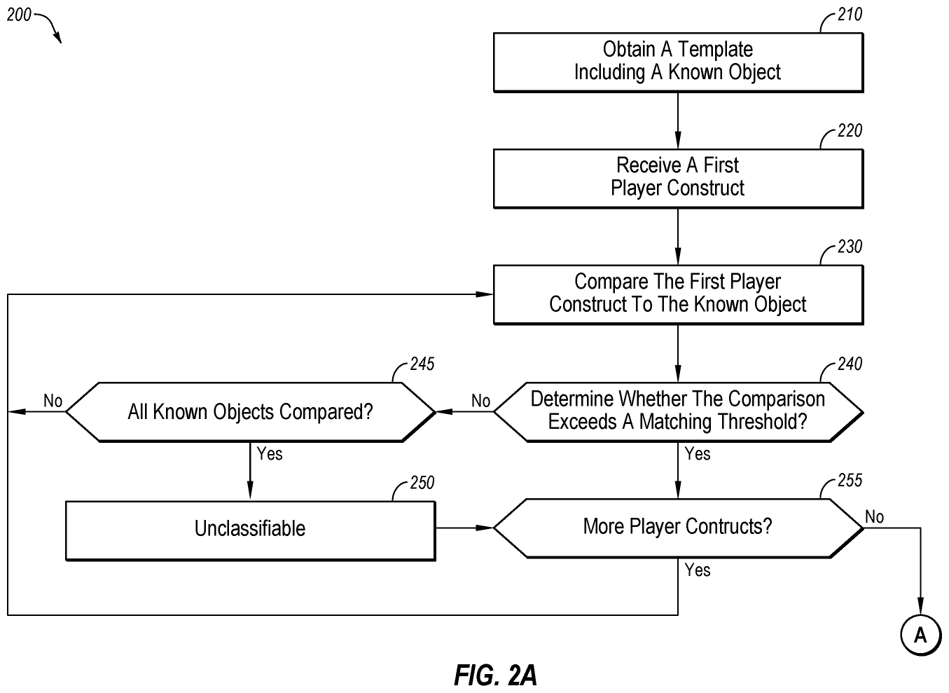

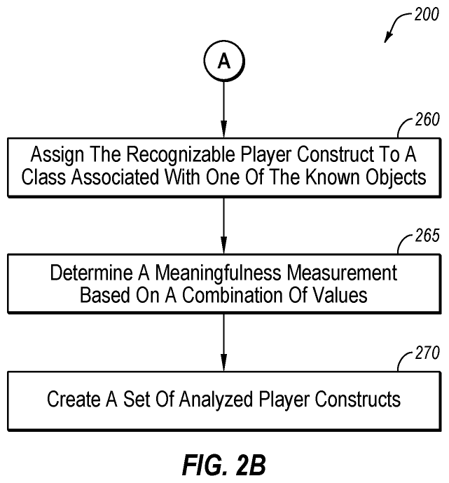

In some embodiments, the computing device 110 may obtain data regarding player constructs 140 and compare them to only a sub-class within a larger class, such as the class of cats within the larger class of animals. If the computing device 110 operates with respect to a class with a more limited scope, such as sea animals, the known objects in this smaller class may be limited to sea animals and then compared to the player construct 140. One example of classifying the player construct 140 may be described in greater detail with respect to FIGS. 2A and 2B.

In some embodiments, the user interface 125 may include a class selection 145 which provides an option for the player, a parent, a doctor, a caregiver, or some other individual associated with the player to select a specific class or set of classes from the user interface 125. Additionally or alternatively, the class selection 145 may include a first option 155 for creation of a custom class of one or more classes of known objects, a second option 160 to allow selection of one or more pre-existing classes from an option of all possible classes, a third option 165 to refine the classes of known objects based on the age or limitations of a player, and/or a fourth option 170 to allow selection of all the classes, encompassing all known objects. In these and other embodiments, the class selection 145 may determine what classes of known objects are measured against the player construct 140 to determine the meaningfulness measurement.

In some embodiments, the computing device 110 and/or the user device 120 may compare the player construct 140 with the known objects to determine whether or not the player construct 140 belongs in a same class as the known object The player construct may be compared to the known object based on a variety of features, including but not limited to the outline or grid or matrix or block-based structure of an image of each of the player construct 140 and the known object. The comparison between the player construct 140 and the known object may occur by determining the amount of overlap between the two structures. If the amount of overlap exceeds a matching threshold, the player construct 140 may be classified within a certain class of known objects associated with the known object. The matching threshold may be altered depending on a player's age, preference, specific limitation, and/or any other of a variety of factors. The classification of the player construct 140 into a class of known objects may occur in conjunction with the matching threshold evaluation or through a separate process. If the overlap between the player construct 140 and the known object does not exceed a matching threshold, the player construct 140 may be compared to other known objects. If the comparison between the player construct 140 and the known object does not exceed the matching threshold, the player construct may be an unrecognizable and unclassifiable player construct.

In some embodiments, the player may receive instruction from the user device 120 while he or she is creating the player construct 140. For example, such instruction may provide guidance as to how the electronic blocks 136 and/or the physical blocks 130 may be moved around to create a different shape. Additionally or alternatively, in other embodiments, the player may receive no instruction as to how the player construct 140 is to be generated. In such embodiments, insights regarding a creative cognition of a player rather than an ability to follow instructions may be evaluated.

Modifications, additions, or omissions may be made to the system 100 without departing from the scope of the present disclosure. The system 100 may include more components or fewer components than those illustrated.

FIGS. 2-6 illustrate various flowcharts related to identification of block-based player constructs. The methods illustrated in FIGS. 2-6 may be implemented by any device or system, such as the system 100, the computing device 110, and/or the user device 120 of FIG. 1. Additionally, modifications, additions, or omissions may be made to the various methods without departing from the scope of the present disclosure. For example, the operations of the methods may be implemented in differing order. Additionally or alternatively, two or more operations may be performed at the same time or they may be performed using different devices. Furthermore, the outlined operations and actions are provided as examples, and some of the operations and actions may be optional, combined into fewer operations and actions, or expanded into additional operations and actions without detracting from the essence of the disclosed embodiments.

FIGS. 2A and 2B illustrate a flowchart of an example method 200 of determining a meaningfulness measurement based on a player construct, in accordance with one or more embodiments of the present disclosure.

At block 210, a template may be obtained. The template may include one or more classes of known objects (such as the known objects of FIG. 1.)

At block 220, a first player construct may be received. For example, a player may generate the first player construct using physical blocks and/or electronic blocks (such as the physical blocks 130 and/or the electronic blocks 136 of FIG. 1). In these and other embodiments, the first player construct may include a digital representation of the physical blocks (e.g., data representative of the overall shape of the physical blocks as indicated by sensors associated with the physical blocks may be received by a computing device) and/or digital representations of the electronic blocks (e.g., data representative of the overall shape of the physical blocks and/or the spatial relationship between the electronic blocks on a display).

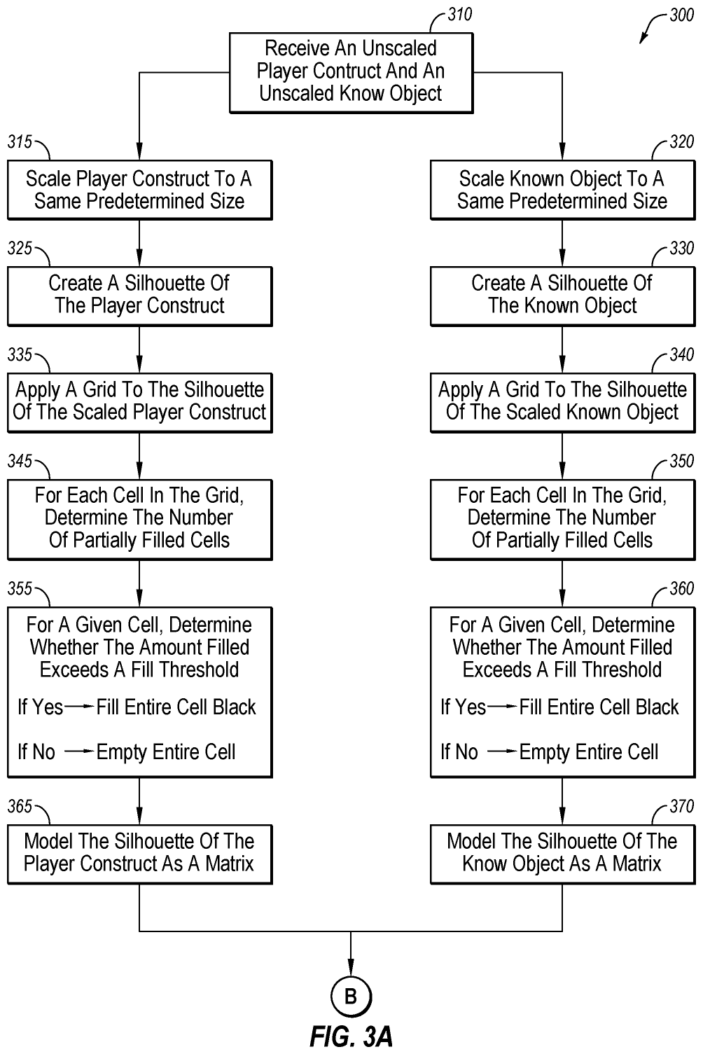

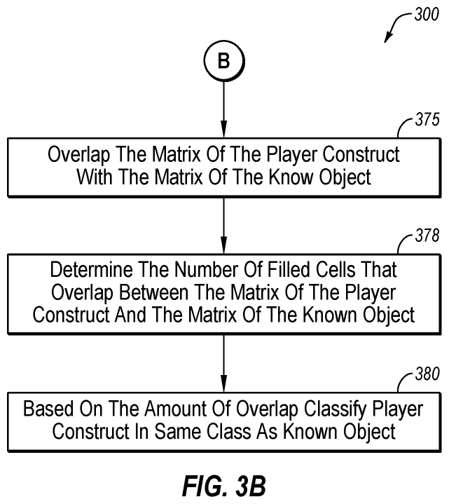

At block 230, the first player construct may be compared to the known object. For example, the first player construct may include a shape of a dog as generated by the player. The first player construct of the dog may be compared to a given known object. In one embodiment, a comparison may be created by individually scaling the first player construct and the known object to a same predetermined size. The predetermined size to which the first player construct and the known object are scaled may be determined based on the original size of the first player construct and/or the known object, or by any other factor. In these and other embodiments, the first player construct and the known object may be segmented into different parts. For example, such segmentation may occur via a matrix, a grid, a set of nodes and edges, and/or some other segmentation method. An example of such a segmentation process is provided with reference to FIGS. 3A and 3B. After the first player construct and the known object have been segmented, the segmented first player construct and the segmented known object may be compared such that an amount of similarity between the two may be determined.

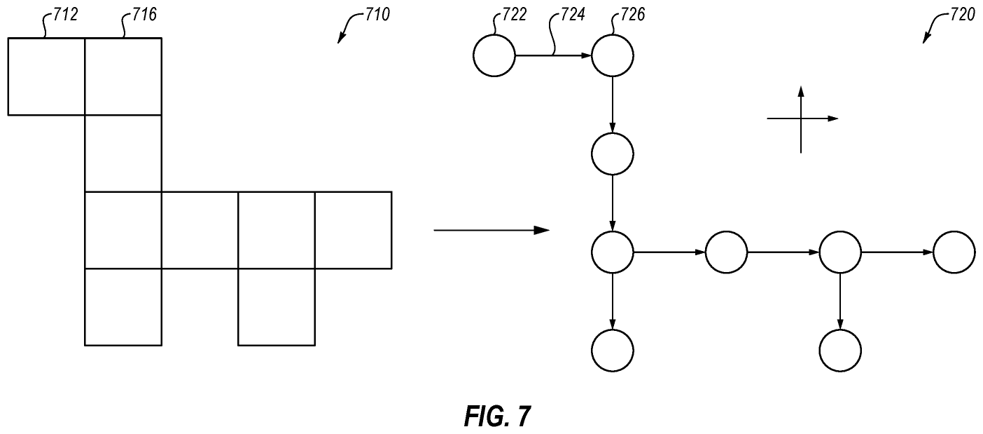

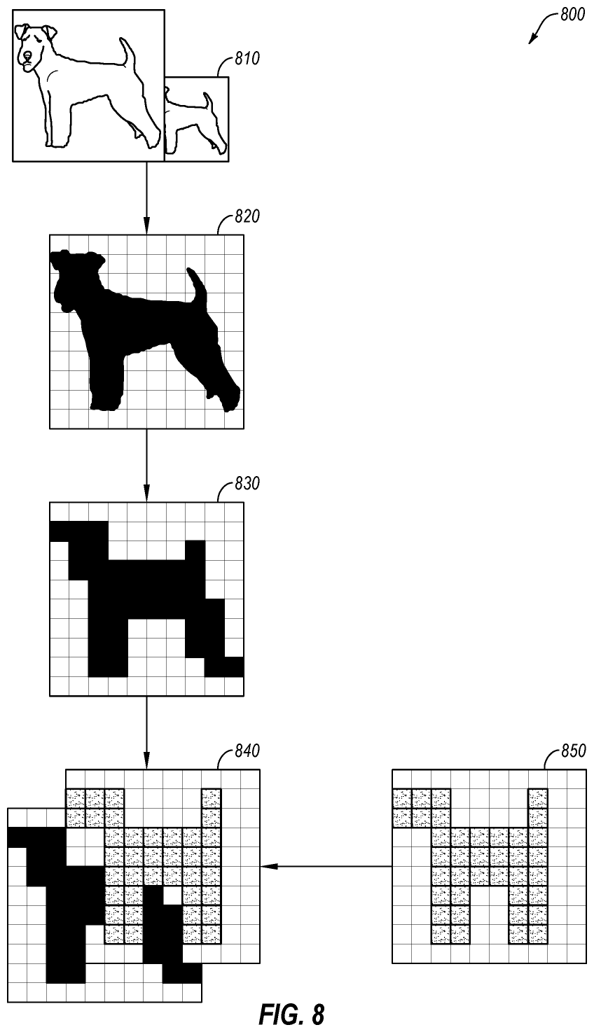

At block 240, a determination may be made as to whether the comparison of the first player construct and the known object exceed a matching threshold. If the amount of similarity determined at the block 230 does not exceed the matching threshold, the method 200 may proceed to the block 245. If the amount of similarity determined at the block 230 exceeds the matching threshold, the method 200 may proceed to the block 255. FIGS. 7 and 8 illustrate various examples of visualizations of the operations of the blocks 230 and 240.

At block 245, a determination may be made as to whether all known objects have been compared to the given player construct. For example, if the first player construct represents a dog and the first known object represents a house, there may be other known objects that represent dogs that have yet to be compared to the first player construct. If all known objects have been compared to the first player construct without exceeding a matching threshold, the method 200 may proceed to the block 250. If less than all of the known objects have been compared to the first player construct, the method 200 may return to the block 230 to compare the first player construct to another known object.

At block 250, the first player construct may be designated as unclassifiable. For example, based on the first player construct not exceeding the matching threshold with any known objects, the first player construct may be designated as unclassifiable.

At block 255, a determination may be made as to whether there are more player constructs to be analyzed and compared to the known objects. If there are more player constructs to analyze, the method 200 may return to the block 230 and compare the other player constructs to the known objects. If there are no more player constructs to compare, the method 200 may proceed to the block 240.

At block 260, a recognizable player construct may be assigned to a class associated with one of the known objects. For example, if the first player construct and a known object of a dog exceeds the matching threshold, the first player construct may be assigned to a class associated with the known object, e.g., dogs.

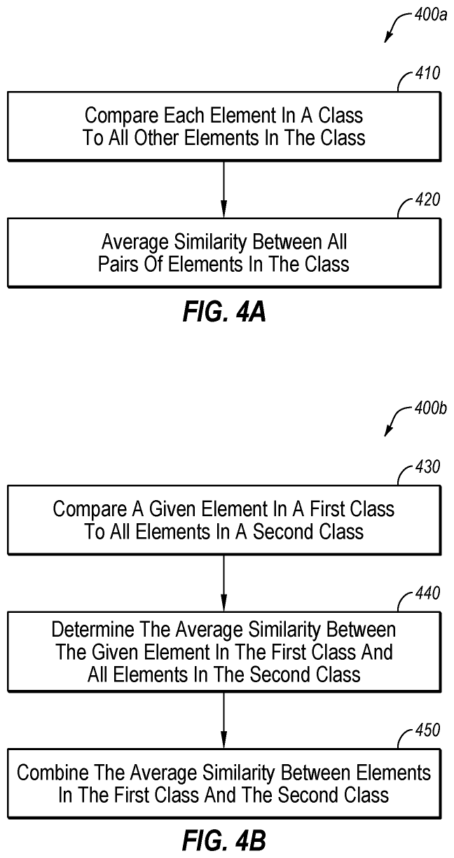

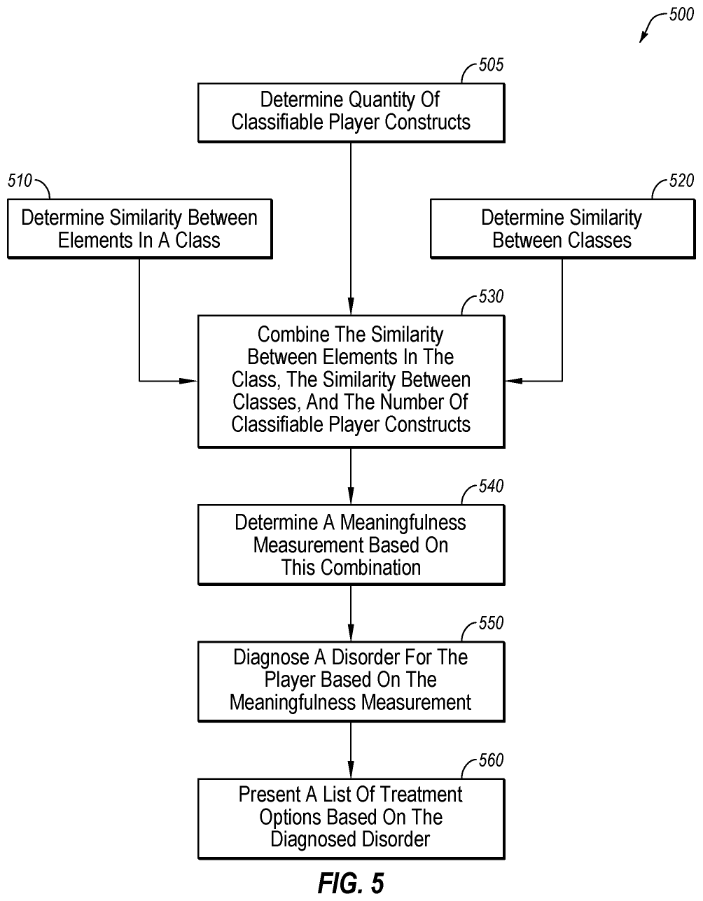

At block 265, a meaningfulness measurement may be determined based on a combination of values, such as a similarity between elements in a class, a similarity between classes, and/or a quantity of recognizable player constructs. Examples of determining the meaningfulness measurement may be described in greater detail with reference to FIGS. 4A, 4B and 5.

In some embodiments, the quantity of classifiable constructs may be determined by comparing the number of player constructs being analyzed with the number of player constructs that were classifiable into classes, for example, as articulated in Equation 1.

$${r}_{i} = \frac{number of classifiable player constructs}{total number of player constructs} \qquad Equation 1$$

where rᵢ may include the quantity of classifiable constructs. In these and other embodiments, the quantity of classifiable constructs may represent a numerical value between zero and one indicative of the number of player constructs that were classifiable out of all potential player constructs.

At block 270, a set of analyzed player constructs may be generated by adding a classified player construct as a known object to a class. This set of analyzed player constructs may provide a training data, providing a set of already analyzed player constructs which may be added as known objects to a class within a template. These player constructs may be stored by a computing device such that when a similarly-shaped player construct is generated by the player, it is recognized as belonging to the same class as the player construct added to the class as a known object.

In some embodiments, a player construct may be added to the set of known objects based on instructions provided to the player. For example, the player may be instructed to generate a dog. After receiving the player construct generated based on the instructions, the received player construct may be added to the set of known objects for the class of dogs, even if the received player construct may not have normally exceeded the matching threshold for that class. In these and other embodiments, by adding such a player construct to a given class, the class may be trained to the particular player such that their version of, for example, a dog may be classified as such.

FIGS. 3A and 3B illustrate an example method 300 of diagnosing a disorder based on a meaningfulness measurement, in accordance with one or more embodiments of the present disclosure.

At block 310, a meaningfulness measurement may be determined. This meaningfulness measurement may be based on a combination of a quantity of classifiable player constructs, a similarity between elements in a class, and a similarity between the class and one or more other classes.

FIGS. 3A and 3B illustrate a flowchart of an example method 300 of classifying a player construct based on the amount of overlap with a known object, in accordance with one or more embodiments of the present disclosure.

At block 310, an unscaled player construct and an unscaled known object may be received. For example, a computing device (such as the computing device 110 of FIG. 1) may receive an unscaled player construct (e.g., from sensors of physical blocks such as the physical blocks 130 of FIG. 1 in the player construct, or from a user device such as the user device 120 of FIG. 1 with electronic blocks 136 arranged in the player construct). Additionally or alternatively, the computing device may receive an unscaled known object from a given class.

At block 315, the player construct may be scaled to a same predetermined size. For example, the computing device may scale the player construct to the same size as the known object is scaled. In some embodiments, the size of the player construct may be determined based on the total number of pixels found in each of the player construct image and the known image. For example, a known object may be 125×125 pixels. If a player uses physical blocks, the image of the player construct shape generated from the data from the embedded sensors in the physical blocks may need to be scaled up or down to match the known object pixel size of 125×125 pixels. In another embodiment, both the image of the known object and the player construct may need to be scaled up or down to reach the same predetermined size.

At block 320, the known object may be scaled to the same predetermined size as the player construct. The block 320 may be similar or comparable to the block 315 but applied to the known object rather than the player construct.

At block 325, a silhouette of a player construct may be created. For example, the outline of the player construct may be determined and some or all of the area within the outline may be filled in. In these and other embodiments, the silhouette may be based on a monochromatic scale.

At block 330, a silhouette of the known object may be created. The block 330 may be similar or comparable to the block 325 but applied to the known object rather than the player construct.

At block 335, a grid may be applied to the silhouette of the player construct. For example, a matrix, square with equally-sized cells, or other grid may be applied to the silhouette of the player construct. In some embodiments, applying the grid may include using square or rectangular blocks or cells and overlaying the silhouette with the grid. In these and other embodiments, the grid may correspond to the number of pixels of the predetermined size such that each pixel corresponds to one cell in the grid.

At block 340, a grid may be applied to the silhouette of the known object. The block 340 may be similar or comparable to the block 335 but applied to the known object rather than the player construct.

At block 345, a number of partially filled cells is determined for each cell in the grid of the silhouette of the player construct. For example, if the edge of the silhouette passes through a cell, that cell may be determined to be a partially filled cell.

At block 350, a number of partially filled cells is determined for each cell in the grid of the silhouette of the known object. The block 350 may be similar or comparable to the block 345 but applied to the known object rather than the player construct.

At block 355, for each given cell in the grid of the silhouette of the player construct, a determination is made as to whether the amount filled exceeds a fill threshold. In some embodiments, the fill threshold may be approximately half of the cell. If the amount filled in the given cell exceeds a fill threshold, the entire cell is filled. If the amount filled in the given cell does not exceed a fill threshold, the entire cell is emptied. In these and other embodiments, after the block 355, each cell in the grid may be completely filled or completely empty such that a binary comparison may be made between each cell as to whether or not it is filled.

At block 360, for each given cell in the grid of the silhouette of the known image, a determination is made as to whether the amount filled exceeds a fill threshold. The block 360 may be similar or comparable to the block 355 but applied to the known object rather than the player construct.

At block 365, the silhouette of the player construct may be modeled as a matrix. For example, if the grid of block 435 includes an N×N grid, the silhouette of the player construct may be represented by an N×N matrix of zeroes and ones indicating that the cells of the grid are empty or filled.

At block 370, the silhouette of the known object is modeled as a matrix. The block 370 may be similar or comparable to the block 365 but applied to the known object rather than the player construct.

At block 375, the matrix of the player construct is overlapped with the matrix of the known object. For example, the elements of one matrix may be shifted to the right or to the left, or up or down by one row/column at a time until the maximum amount of overlap is obtained between the two matrices. As another example, if the silhouette of the known object and the silhouette of the player construct are compared without representation as matrices (e.g., if blocks 365 and 370 are omitted), the origin of the grid of one of the player construct or the know object may be shifted (e.g., moved up/down and/or left/right) relative to the origin of the other until a maximum amount of overlap is obtained between the player construct and the known object. A depiction of the analysis of such overlap may be described in more detail with reference to FIG. 8B.

At block 378, the number of filled cells that overlap between the matrix of the player construct and the matrix of the known object may be determined. For example, after the overlap is maximized or otherwise performed at the block 375, the number of cells that do overlap may be determined. For example, using the matrix description above, any of the cells that do not overlap (e.g., have the same value in the same matrix position) may be counted and the total number determined. In some embodiments, the number of cells that overlap may be divided by the total number of potential cells to yield a numerical value between zero and one or a percentage indicative of the similarity between the player construct and the known object.

In some embodiments, the overlap of the matrices of block 475 and the determination of the overlap of block 478 may be described mathematically. For example, the first player construct may be labelled as M₁, and the second player construct may be labelled as M₂, the number of filled cells within M₁ may be referred to as c₁ and the number of filled cells within M₂ may be referred to as c₂, and the term nMatching may represent the number of matrix elements that match between M₁ and M₂ for the possible alignments [M₁(i, j), M₂(0, 0)]. Using such annotation, similarity may be determined between M₁, M₂ in Equation 2.

similarity(M₁,M₂)=max(nMatching)/max(c₁,c₂) Equation 2:

where max may represent an identification of a maximal value, max(nMatching) may determine the highest value for nMatching over the various alignments, and max(c₁, c₂) may represent the highest number of filled cells between c₁ and c₂ (e.g., if c₁ includes 60 filled cells and c₂ includes 75 filled cells, the result of the function max(c₁, c₂) may yield 75).

In some embodiments, the two player constructs to be compared may be represented in a graph form instead of a matrix or image form. Such graph forms may include a series of nodes and edges. An example illustration of such a graph form may be depicted in FIG. 8A. According to such an embodiment, the first player construct may correspond to a graph i and the second player construct may correspond to a graph j. To determine the similarity (similarity) between the two player constructs, the two graph i and j may be overlapped. The maximum number of edges in graph i and j may be determined. A common subgraph k may be determined based on the area providing the greatest amount of overlap between graphs i and j. Using the subgraph k, the maximum number of edges in k may be determined. Additionally, the larger number of edges of graph i and graph j may be determined. Equation 3 provides an example mathematical description of how to determine similarity between the graphs i and j, namely, by comparing the number of edges in common to the maximum number of edges between the two graphs.

$$similarity ( i , j ) = \frac{\# of edges in k}{max ( \# of edges in i , \# of edges in j )} \qquad Equation 3$$

In some embodiments, distance may be used to denote the opposite of similarity between two elements (e.g., between the first player construct and the known object). The distance between two elements may be described mathematically as depicted in Equation 4.

distance(i,j)=1−similarity(i,j) Equation 4:

At block 380, depending on the amount of overlap, the player construct may be classified in the same class as the known object. For example, if the number of cells and/or the numerical value between zero and one exceeds a matching threshold, the player construct may be determined to be similar enough to the known object to be classified in the same class as the know object. In some embodiments, the numerical threshold may include a value between and including approximately 0.5 and 1.0, such as between 0.65 and 0.85. As another example, if the similarity value exceeds the matching threshold, the first player construct may be similar enough to the known object to be classified in the same class as the known object.

While FIGS. 3A and 3B have been articulated with respect to a player construct and a known object, the same process may be applied to two player constructs to yield the similarity between the two player constructs as determined at the block 378. Thus, the method 300 may provide a process by which similarity between any two elements may be determined. In some embodiments, the difference between two elements may be articulated as the numerical opposite of the similarity between the two elements. For example, if the number between zero and one is used to articulate the similarity, the difference may be articulated as one minus the similarity.

FIG. 4A illustrates a flowchart of an example method 400a of determining similarity between elements within a class, in accordance with one or more embodiments of the present disclosure.

At block 410, a comparison may be made between each element in a class of player constructs to all other elements in the class of player constructs. For example, the method 200 of FIGS. 2A and 2B may be completed for multiple player constructs, yielding at least one class with multiple player constructs as elements of that class. Each potential pair of elements (e.g., for 3 elements, 1-2, 1-3, 2-3) may be compared to yield a similarity associated with each potential pair of the elements in the class. In some embodiments, the comparison may be performed according to the method 300 of FIGS. 3A and 3B to yield the similarity. For example, the similarity may represent the amount of overlap between the various potential pairs of elements of the class.

At block 420, the similarity between all the pairs of elements in the class may be averaged. For example, each comparison may yield a numerical value indicative of the similarity between each potential pair, and that numerical value for each potential pair may be averaged to yield the similarity between the elements of the class as represented by a single numerical value.

In some embodiments, the determination of the amount of similarity between elements within a class may be determined as expressed in Equation 5 (below). For example, same_class_similarity may represent the similarity between the various elements in the class Cⱼ, with elements (c) in the class, and having m elements in the class. The class elements c may be denoted by the subscripts p and q to differentiate between different elements.

$$same\_class {\_similarity}_{{C}_{j}} = \frac{{\sum }_{p = 1}^{m} {\sum }_{q = p + 1}^{m} ( similarity ( {c}_{p} , {c}_{q} ) )}{\frac{m ( m - 1 )}{2}} \qquad Equation 5$$

where similarity may be determined as described above with reference to FIGS. 2 and 3. Using Equation 5, the similarity between the various elements may be summed, and divided by the number of elements in the class Cⱼ to yield an average similarity across all similarities of all pairs of elements in the class.

In some embodiments, the average of the same_class_similarity across all classes may be determined to provide an indication of the similarity between elements in a class across all classes of player constructs for a player. For example, a set of all classes (Sᵢ) of the player constructs analyzed for the player may be analyzed to determine a total_same_class_similarity, as articulated in Equation 6.

$$total\_same \_class {\_similarity}_{{S}_{i}} = \frac{{\sum }_{k = 1}^{n} same\_class {\_similarity}_{{C}_{k}}}{n} \qquad Equation 6$$

where Cₖ may represent a given class C distinguished by the subscript k, and n represents the number of classes in the set Sᵢ. Using the above-equation, the total_same_class_similarity may represent the average amount of similarity between the elements in the classes of player constructs. Such an approach may yield a numerical value representative of how similar the various class elements were within a given class, across all classes.

FIG. 4B illustrates a flowchart of an example method 400b of determining similarity between multiple classes, in accordance with one or more embodiments of the present disclosure.

At block 430, a comparison may be made between a given element in a first class and the elements in a second class. If more than two classes of player constructs are to be analyzed, the comparison may be performed for each element of each class relative to each other class. For example, if a player creates several different player constructs of animals, the similarity between each subclass within the animals may be compared. Continuing the example, if the player creates player constructs of birds, dogs, and cats, a given element of the bird player constructs may be compared to the elements of the dog player constructs, and the cat player constructs, and repeated for each element of the dog player constructs, etc. In some embodiments, the comparison of the given element in the first class with the elements in the second class may be performed according to the method 300 of FIGS. 3A and 3B to yield the similarity. For example, the similarity may represent the amount of overlap between the various elements of the classes.

At block 440, the average similarity between the given element in the first class and all elements in the second class may be determined. For example, the numerical similarity value for the given element and all elements in the second class may be averaged to yield a total similarity between the given element and the second class.

At block 450, the average similarity between elements in the first class and the second class may be determined. For example, the average similarity for each of the elements in the first class relative to the second class may be averaged to yield a single numerical value representative of the similarity between the first class and the second class.

In some embodiments, the methods 400a and/or 400b may be repeated for all classes for which player constructs have been classified such that all player constructs may be analyzed and a similarity between elements in a given class and similarity between the classes may be determined for a given player. In these and other embodiments, the similarity between the various elements may be determined as an amount of overlap between the various elements.

In some embodiments, the amount of similarity between elements within a class (e.g., the player constructs classified into the class) may be determined by estimating the amount of overlap between each possible pair of elements in the class, and averaging the amount of overlap. For example, when the player constructs are divided into a grid or matrix and sized to a comparable size, the amount of similarity may be calculated by summing the total number of filled cells in the grid found in a given pair of elements, and determining the difference in the total number of filled cells. In these and other embodiments, the filled cells may operate on a binary principle, as either filled or empty. When the total number of filled cells is determined for each of the two player constructs being compared, the two may be aligned. For example, the two player constructs may be aligned by varying the origin of the two player constructs relative to each other to maximize the amount of overlap of filled cells. After maximizing the overlap, the number of cells that overlap may be indicative of the similarity between the two player constructs.

In some embodiments, the similarity between classes may be determined mathematically as described below. For example, the similarity (multi_class_similarity) between the elements in two classes (classes Cₚ and C_{q}) including a set number of elements (r and s elements, respectively) may be determined according to Equation 7.

$$multi\_class \_similarity ( {C}_{p} , {C}_{q} ) = \frac{{\sum }_{x = 1}^{r} {\sum }_{y = 1}^{s} ( similarity ( {c}_{x} , {c}_{y} )}{r \cdot s} \qquad Equation 7$$

where cₓ may represent an element in class Cₚ and c_{y} may represent an element in class C_{q}. Using Equation 7, the similarity between the two classes may represent an average of the similarities between all potential pairings of elements in class Cₚ with those in class C_{q}.

In some embodiments, the determination of multi_class_similarity between two classes may be repeated and performed across all classes of player constructs as generated by the player, such that a total numerical value representing the similarity between elements of different classes across all classes may be determined. For example, for the set Sᵢ of all player constructs across all classes (C), including n classes, a total_multi_class_similarity may be determined as articulated in Equation 8.

$$total\_multi \_class {\_similarity}_{{S}_{i}} = \frac{{\sum }_{p = 1}^{n} {\sum }_{q = p + 1}^{n} ( multi\_class \_similarity ( {C}_{p} , {C}_{q} ) )}{\frac{n ( n - 1 )}{2}} \qquad Equation 8$$

where Cₚ and C_{q} represent different classes. Using Equation 8, the total similarity between the various class pairings of the classes of Sᵢ may be determined.

FIG. 5 illustrates a flowchart of another example method 500 of determining a meaningfulness measurement, in accordance with one or more embodiments of the present disclosure.

At block 505, a quantity of player constructs that are classifiable may be determined. For example, a player may generate a set of player constructs that may be classified into multiple classes. In some embodiments, the quantity of player constructs that are classifiable may represent a value between zero and one representative of the number of player constructs that were classified into a class compared to all player constructs generated (e.g., including both player constructs that were classified and those that were unclassifiable). In some embodiments, the quantity may be represented by and/or determined as rᵢ as described above with respect to Equation 1

At block 510, similarity between elements in a class may be determined. For example, for a first class of classified player constructs, the similarity between the elements in that class may be determined, for example, as described with reference to FIG. 4A. In some embodiments, a total similarity across all classes may be determined that is representative of the average similarity across elements in a single class, averaged across all classes.

At block 520, similarity between classes may be determined. For example, the similarity between the elements in the various classes may be determined to articulate how close the different classes are to each other. For example, if one class represents dogs and another class represents cars, the similarity between the classes may represent how similar the dogs are to the cars. The similarity between classes may include the average of a determined similarity across all potential pairings of classes. The similarity between classes may be determined as described with respect to FIG. 4B.

At block 530, the similarity between elements in a class, the similarity between classes, and a quantity of recognizable player constructs may be combined. In some embodiments, the quantity of recognizable player constructs may be determined as a total number of player constructs classifiable compared to the total number of player constructs generated (e.g., rᵢ as described above with respect to Equation 1). Additionally or alternatively, the similarity between elements in the class may be represented by total_same_class_similarity as described above with respect to Equation 6, and the similarity between classes may be represented by total_multi_class_similarity as described above with respect to Equation 8. In these and other embodiments, the combination may include a multiplicative combination, or any other mathematical, statistical, or other combinatorial technique.

At block 540, a meaningfulness measurement may be determined based on the combination of the similarity between classes, the similarity between elements in a class, and the quantity of recognizable player constructs. In some embodiments, the combination of block 535 may directly be the meaningfulness measurement. Additionally or alternatively, other processing, statistical analysis, or other variation may be performed on the combination resulting in the meaningfulness measurement.

At block 550, a disorder may be diagnosed for a player that generated the player constructs based on the meaningfulness measurement determined at the block 540. For example, the meaningfulness measurement may indicate a player is on the autism spectrum or struggles with attention deficit disorder, that the player has dysgraphia or that the player has bipolar disorder or anxiety disorder.

At block 560, a list of treatment options may be presented based on the disorder diagnosed at the block 550. For example, a physician, doctor, psychologist, etc. may be presented with treatment options and/or suggestions based on the diagnosed disorder. Additionally or alternatively, the player or a parent/guardian of the player may be directed to a list of physicians familiar with, resources regarding, etc. the diagnosed disorder. Additionally or alternatively, a computing device may provide the player with one or more additional tests or activities to provide further clarification or a greater degree of confidence in the diagnosed disorder.

FIG. 6 illustrates a flowchart of another example method 600 of evaluating a player construct based on received language from a player while generating a player construct, in accordance with one or more embodiments of the present disclosure.

At block 610, the voice of the player may be obtained while making the player construct. For example, a microphone of a computing device and/or a sensor on a block may obtain the voice of the player while generating the player construct and may provide the voice to a computing device.

At block 620, voice recognition may be performed on the voice of the player. Voice recognition may occur through simple pattern matching, pattern and feature analysis, language modeling, statistical analysis, through artificial networks, or any other voice recognition technique. In some embodiments, the voice recognition may be trained to the voice of the player or may utilize generic voice recognition. The voice recognition may produce text corresponding to the words spoken by the player.

At block 630, the text is processed. Such processing may include any of a variety of processing techniques. For example, tokenization may be performed on the output of the voice recognition to break the words or text into meaningful words or other tokens. As another example, stemming may be performed on the output of the voice recognition (e.g., taking the word “doggie” and reducing it to the stem “dog”). As an additional example, stop words (e.g., “a,” “the,” “is,” etc.) may be removed from the output of the voice recognition. As another example, the part of speech for the words in the text may be tagged (e.g., “dog” as a noun, “furry” as an adjective, etc.).

At block 640, key text may be identified. For example, if the output of the processing of block 630 includes the words “dog,” “bone,” “run,” “play,” etc., the nouns “dog” and “bone” may be identified as key text. In some embodiments, the identification of key text may be based on lexical hierarchy. For example, one or more of the text output from the processing and/or otherwise identified key textual words may be traced back in a relational database (e.g., based on “has-a” or “is-a” relationships). For example, the terms “wheel,” “engine,” and “window,” may include a “has-a” relationship with a “car,” while “car” has an “is-a” relationship with “motor vehicle.” In these and other embodiments, a common ancestor for multiple words may be included as key text and/or may be otherwise utilized in the method 600.

At block 650, a class may be suggested based on the key text. For example, based on the key words, “dog” and “chew bones,” the class of animals may be suggested. In some embodiments, the class suggested may be based on the common ancestor in the lexical hierarchy. For example, if the words “engine” and “wheel” were included as key text, a common ancestor may include “car,” and so “car” may be suggested as the class. In some embodiments, the suggestion of the class may include lowering a matching threshold for known objects for the suggested class such that the player construct may be more likely to exceed the matching threshold for known objects in the suggested class.

FIG. 7 illustrates a visual depiction of an example process 700 by which a player construct 710 may be converted from blocks to a set 720 of edges and nodes, in accordance with one or more embodiments of the present disclosure.

As illustrated in FIG. 7, a player may generate the player construct 710 out of blocks. The blocks may include physical blocks or electronic blocks as described with respect to FIG. 1. In some embodiments, the player construct 710 may be obtained by a computing device, such as the computing device 110 of FIG. 1.

In some embodiments, the center of each of the blocks of the player construct 710 may be represented as a respective node. For example, the block 712 may be represented by the node 722 and the block 716 may be represented by the node 726. In these and other embodiments, the computing device may determine surfaces that are shared between blocks and may create corresponding edges between such adjacent blocks. For example, the blocks 712 and 716 share a surface and that shared surface may be represented by the edge 724. Such a process of identifying nodes and edges for each of the blocks of the player construct 710 to generate the set 720 of edges and nodes.

In some embodiments, the nodes of the set 720 may be oriented with respect to an x and y axis, where the distance between a first node and a second node may be measured across the x, the y axis, or both. In some embodiments, the distance between nodes may be normalized such that each edge of the set 720 is the same distance, or integer multiples of the same distance (e.g., 1×, 2×, or 3× the distance). In some embodiments, the set 720 of nodes and edges may be scaled to a predetermined size or dimension such that all player constructs and/or known objects may be compared at a comparable size.

FIG. 8 illustrates a process 800 by which a comparison between player constructs or between a player construct and a known object may occur, in accordance with one or more embodiments of the present disclosure. The comparison illustrated in in FIG. 8 may be similar or comparable to that used to determine whether a matching threshold is exceeded when comparing a known object and a player construct. Additionally or alternatively, the comparison illustrated in FIG. 8 may be used in determining a similarity between a first element of a class with a second element of the same class or another class. In some embodiments, various depictions of FIG. 8 may be similar or comparable to the operations described with reference to FIGS. 4A and 4B.

As illustrated in FIG. 8, an image 810 of a known object may be obtained (for example, as described at block 410 in FIG. 4A). The image 810 may or may not be scaled such that the image is an approximate size (for example, as described at block 420 in FIG. 4A). The image 810 may be provided in a web search, an uploaded image, or some other process of obtaining an image of a known subject.

In some embodiments, a silhouette 820 of the known object may be created based on the image 810 of the known object (for example, as described at block 430 in FIG. 4B). Additionally or alternatively, a grid may be applied to the silhouette 820 (for example, as described at block 440 in FIG. 4A).

In some embodiments, based on the grid, a filled-cell image 830 may be generated. The filed-cell image 830 may include cells that are filled or cells that are empty. For example, as described above with respect to blocks 450 and 460 of FIG. 4B, the cells of the grid overlaid on the silhouette 830 that are partially filled may be either completely filled or completely emptied.

In some embodiments, a player construct 840 may be obtained. The player construct may be made of blocks which may align to a grid that may be the same size as the grid applied to the silhouette 820. Additionally or alternatively, the player construct 840 may be scaled to a comparable size as the silhouette and may have a same or similar grid applied to the player construct (for example, as described with respect to the block 335 of FIG. 3A).

In these and other embodiments, the player construct 840 and the filled-cell image 830 may be overlapped as illustrated by the overlapped image 850. The overlapped image 850 may illustrate a partial overlap of the player construct 840 and the filled-cell image 830. As described above with respect to block 375 of FIG. 3B, the alignment of the overlapped image 850 may be adjusted to find a maximal amount of overlap between the player construct 840 and the filled-cell image 830. Such a process may include adjusting the origin of one relative to the other. Additionally or alternatively, the player construct 840 and/or the filled-cell image 830 may be represented by matrices and the portions of the matrices representative of the filled cells may be shifted within the matrix to maximize the overlap between the matrices.

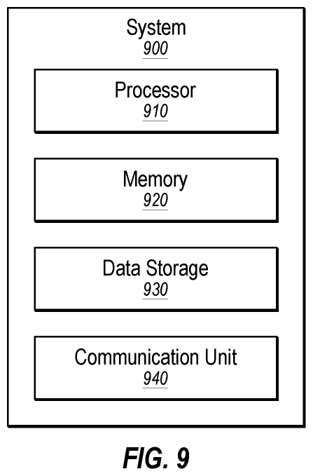

FIG. 9 illustrates an example system 900, in accordance with one or more embodiments of the present disclosure. The system 900 may be a computing device, such as the computing device 110 of FIG. 1, the user device 120 of FIG. 1, the physical blocks 130 of FIG. 1, and/or any other computing device. The system 900 may be configured to facilitate the performance of one or more of the operations described in conjunction with the present disclosure. For example, the system 900 may perform one or more of the operations illustrated in FIGS. 2-6.

The system 900 may include any suitable system, apparatus, or device configured to communicate over a network. The system 900 may include a computing device (such as the computing device 110 in FIG. 1) or a user device (such as the user device 120 in FIG. 1). The system 900 also includes a processor 910, a memory 920, a data storage 930, and a communication unit 940, which all may be communicatively coupled.

Generally, the processor 910 may include any suitable special-purpose or general-purpose computer, computing entity, or processing device including various computer hardware or software modules and may be configured to execute instructions stored on any applicable computer-readable storage media. For example, the processor 910 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 9, it is understood that the processor 910 may include any number of processors distributed across any number of network or physical locations that are configured to perform individually or collectively any number of operations described in the present disclosure. In some embodiments, the processor 910 may interpret and/or execute program instructions and/or process data stored in the memory 920, the data storage 930, or the memory 920 and the data storage 930. In some embodiments, the processor 910 may fetch program instructions from the data storage 930 and load the program instructions into the memory 920.

After the program instructions are loaded into the memory 920, the processor 910 may execute the program instructions, such as instructions to perform the methods 200, 300, 400, 500, and/or 600 of FIGS. 2, 3, 4, 5, and 6, respectively. For example, the processor 910 may obtain instructions regarding determining the size of a player construct image or a known object image, whether that image needs to be scaled to a particular size, what that pixel or other size may be, and other instructive purposes. As another example, the processor 910 may obtain instructions regarding the implementation of a user interface, such as the user interface 125 of FIG. 1.

The memory 920 and the data storage 930 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 910. In some embodiments, the computing system 900 may or may not include either of the memory 920 and the data storage 930.

By way of example, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store desired program code in the form of computer-executable instructions or data structures and which may be accessed by a general-purpose or special-purpose computer. The non-transitory computer-readable medium may have stored therein executable code with instructions for the performance of operations. Combinations of the above may also be included within the scope of computer-readable storage media. Computer-executable instructions may include, for example, instructions and data configured to cause the processor 910 to perform a certain operation or group of operations.

The communication unit 940 may include any component, device, system, or combination thereof that is configured to transmit or receive information over a network. In some embodiments, the communication unit 940 may communicate with other devices at other locations, the same location, or even other components within the same system. For example, the communication unit 940 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 740 may permit data to be exchanged with a network and/or any other devices or systems described in the present disclosure. For example, the communication unit 940 may allow the system 900 to communicate with other systems, such as computing devices and/or other networks.

Modifications, additions, or omissions may be made to the system 900 without departing from the scope of the present disclosure. For example, the data storage 930 may include multiple different storage mediums located in multiple locations and accessed by the processor 910 through a network.

As indicated above, the embodiments described in the present disclosure may include the use of a special purpose or general purpose computer (e.g., the processor 910 of FIG. 9) including various computer hardware or software modules, as discussed in greater detail below. Further, as indicated above, embodiments described in the present disclosure may be implemented using computer-readable media (e.g., the memory 920 or data storage 930 of FIG. 9) for carrying or having computer-executable instructions or data structures stored thereon. In some embodiments, one or more of the operations illustrated in FIGS. 2-6 may be implemented using such software modules which may be stored in the memory 920 to be implemented by the processor 910.

As used in the present disclosure, the terms “user device” or “computing device” or “non-transitory computer readable medium” may refer to specific hardware implementations configured to perform the actions of the module or component and/or software objects or software routines that may be stored on and/or executed by general purpose hardware (e.g., computer-readable media, processing devices, or some other hardware) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated. In this description, a “computing device” may be any computing system as previously defined in the present disclosure, or any module or combination of modules running on a computing device.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, and/or others) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

What is claimed is:

1. A method comprising;
obtaining a plurality of known objects;
receiving a player construct;
comparing the player construct to the plurality of known objects to determine whether a comparison of the player construct and one of the plurality of known objects exceeds a matching threshold;
based on the comparison exceeding the matching threshold, assigning the player construct to a class associated with the one of the plurality of known objects; and
determining a meaningfulness measurement based on a quantity of player constructs, including the player construct, that exceed the matching threshold with any of the plurality of known objects, a similarity between elements in the class, and a similarity between the class and one or more other classes.

2. The method of claim 1, wherein determining the meaningfulness measurement further comprises combining the quantity of recognizable player constructs with the similarity between elements in the class and by the similarity between the classes.

3. The method of claim 1, further comprising using the meaningfulness measurement to diagnose a disorder in a player that generated the player construct.

4. The method of claim 1, wherein the player construct includes data from embedded sensors in a plurality of physical blocks, the data representative of location data such that the player construct includes an overall shape of the plurality of physical blocks.

5. The method of claim 1, wherein the player construct includes data representing a plurality of electronic blocks, the data representative of location data such that the player construct includes an overall shape of the plurality of electronic blocks.

6. The method of claim 1, further comprising:
scaling the player construct and one of the plurality of known objects to a same predetermined size;
applying a grid to the player construct and the one of the plurality of known objects; and
for each cell in the grid that is partially filled:
determining whether an amount filled exceeds a fill threshold for a given cell; and
based on the amount filled exceeding the fill threshold for the given cell, filling the given cell.

7. The method of claim 8, wherein comparing the player construct to the plurality of known objects comprises comparing the scaled and filled player construct with the scaled and filled one of the plurality of known objects to determine a number of filled cells within the grid of the player construct that overlap with filled cells within the grid of the one of the plurality of known objects.

8. The method of claim 9, wherein determining the similarity between elements in the class includes:
comparing each element in the class with all other elements in the class to determine a number of filled cells that overlap between a pair of elements to determine an amount of overlap; and
averaging the amount of overlap between all pairs of elements within the class.

9. The method of claim 9, wherein determining the similarity between the class and one or more other classes includes:
for each element in a first class, comparing a given element in the first class with all elements in a second class to determine an average number of filled cells that overlap between the given element in the first class and the elements in the second class; and
combining the average number of filled cells that overlap between all elements in the first class with the elements in the second class to derive similarity between the first class and the second class.

10. The method of claim 1 further comprising receiving language from a player while receiving the player construct and wherein the matching threshold is based on the received language.

11. The method of claim 1 further comprising customizing a training data set based on a known object and an analyzed player construct that exceeds the matching threshold.

12. A non-transitory computer readable medium having stored therein executable code that, when executed by a processor, causes the processor to perform or control performance of operations, the operations comprising:
obtaining a plurality of known objects;
receiving a player construct;
comparing the player construct to the plurality of known objects to determine whether a comparison of the player construct and one of the plurality of known objects exceed a matching threshold;
based on the comparison exceeding the matching threshold, assigning the player construct to a class associated with the one of the plurality of known objects; and
determining a meaningfulness measurement based on a quantity of player constructs, including the player construct, that exceed the matching threshold with any of the plurality of known objects, a similarity between elements in the class, and a similarity between the class and one or more other classes.

13. The non-transitory computer readable medium of claim 12, wherein the player construct includes data from embedded sensors in a plurality of physical blocks, the data representative of location data such that the player construct includes an overall shape of the plurality of physical blocks.

14. The non-transitory computer readable medium of claim 12, wherein the player construct includes data representing a plurality of electronic blocks, the data representative of location data such that the player construct includes an overall shape of the plurality of electronic blocks.

15. The non-transitory computer readable medium of claim 12, further comprising:
scaling the player construct and one of the plurality of known objects to a same predetermined size;
applying a grid to the player construct and the one of the plurality of known objects; and
for each cell in the grid that is partially filled:
determining whether an amount filled exceeds a fill threshold for a given cell; and
based on the amount filled exceeding the fill threshold for the given cell, filling the given cell.

16. The non-transitory computer readable medium of claim 15, wherein comparing the player construct to the plurality of known objects comprises comparing the scaled and filled player construct with the scaled and filled one of the plurality of known objects to determine a number of filled cells within the grid of the player construct that overlap with filled cells within the grid of the one of the plurality of known objects.

17. The non-transitory computer readable medium of claim 16, wherein determining the similarity between elements in the class includes:
comparing each element in the class with all other elements in the class to determine a number of filled cells that overlap between a pair of elements to determine an amount of overlap; and
averaging the amount of overlap between all pairs of elements within the class.

18. The non-transitory computer readable medium of claim 17, wherein determining the similarity between the class and one or more other classes includes:
for each element in a first class, comparing a given element in the first class with all elements in a second class to determine an average number of filled cells that overlap between the given element in the first class and the elements in the second class; and
combining the average number of filled cells that overlap between all elements in the first class with the elements in the second class to derive similarity between the first class and the second class.

19. A system comprising:
a memory; and
a processor operatively coupled to the memory, the processor being configured to execute instructions to:
obtain a includes a plurality of known objects;
receive a player construct;
compare the player construct to the plurality of known objects to determine whether a comparison of the player construct and one of the plurality of known objects exceeds a matching threshold;
based on the comparison exceeding the matching threshold, assign the player construct to a class associated with the one of the plurality of known objects; and
determine a meaningfulness measurement based on a quantity of player constructs, including the player construct, that exceeds the matching threshold with any of the plurality of known objects, a similarity between elements in the class, and a similarity between the class and one or more other classes.

20. The system of claim 19, wherein the player construct includes data from embedded sensors in a plurality of physical blocks, the data representative of location data such that the player construct includes an overall shape of the plurality of physical blocks.
